(19) United States
(12) Patent Application Publication
(10) Pub. No.: US 2018/0098534 A1
(43) Pub. Date: Apr. 12, 2018

(54) Flying Decoy Assembly

(71) Applicant: Karl Schmidt, Farmville, VA (US)

(72) Inventor: Karl Schmidt, Farmville, VA (US)

(21) Appl. No.: 15/290,126

(22) Filed: Oct. 11, 2016

(51) Int. Cl. A01M 31/06

(52) U.S. Cl. CPC A01M 31/06

(57) ABSTRACT

A flying decoy assembly includes a balloon is filled with helium. Thus, the balloon floats in the air. The balloon has the ornamental appearance of a water fowl in flight. Thus, the balloon attracts water fowl. A restraint is provided. The restraint is positioned on the ground such that the restraint is positioned in a selected area. The balloon is coupled to the restraint. Thus, the restraint retains the balloon near the selected area.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to decoy devices and more particularly pertains to a new decoy device for flying a decoy to attract water fowl.

### BRIEF SUMMARY OF THE INVENTION

An embodiment of the disclosure meets the needs presented above by generally comprising a balloon is filled with helium. Thus, the balloon floats in the air. The balloon has the ornamental appearance of a water fowl in flight. Thus, the balloon attracts water fowl. A restraint is provided. The restraint is positioned on the ground such that the restraint is positioned in a selected area. The balloon is coupled to the restraint. Thus, the restraint retains the balloon near the selected area.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a balloon of a flying decoy assembly according to an embodiment of the disclosure.

FIG. 2 is a bottom view of a balloon of an embodiment of the disclosure.

FIG. 3 is a left side view of a balloon of an embodiment of the disclosure.

FIG. 4 is a cross sectional view taken along line 4-4 of FIG. 3 of an embodiment of the disclosure.

FIG. 5 is a perspective in-use view of an embodiment of the disclosure.

### DETAILED DESCRIPTION OF THE INVENTION

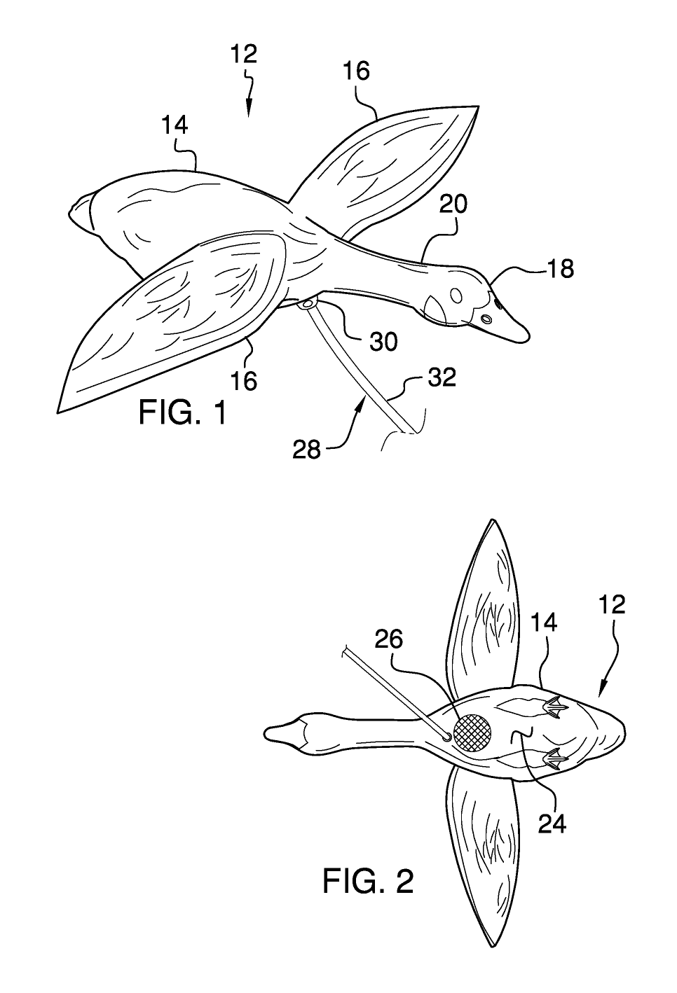

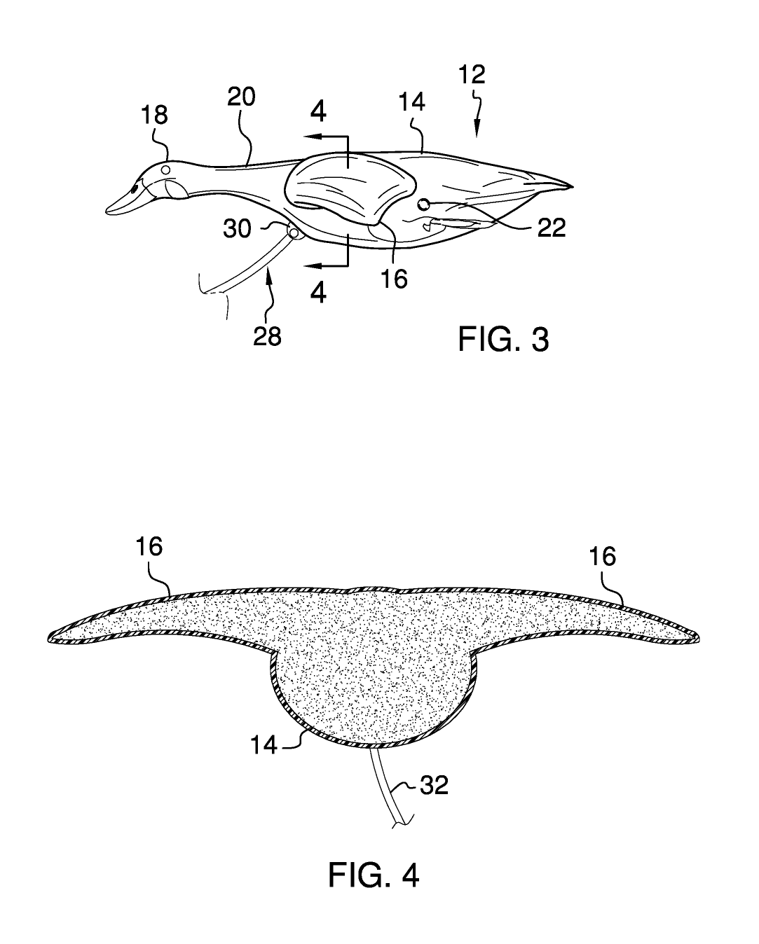

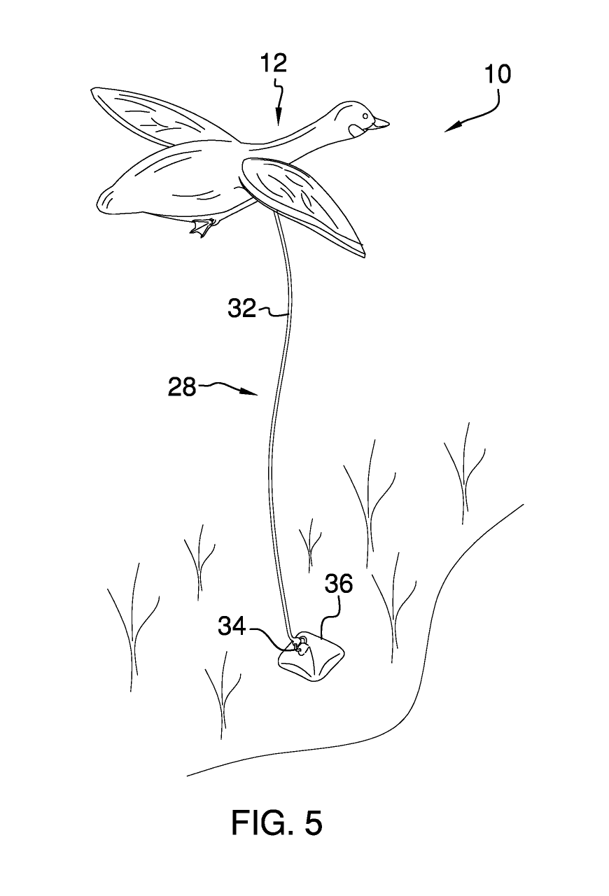

With reference now to the drawings, and in particular to FIGS. 1 through 5 thereof, a new decoy device embodying the principles and concepts of an embodiment of the disclosure and generally designated by the reference numeral 10 will be described.

As best illustrated in FIGS. 1 through 5, the flying decoy assembly 10 generally comprises a balloon 12 that is filled with helium thereby facilitating the balloon 12 to float in the air. The balloon 12 has a body 14 and a pair of wings 16 extending away from the body 14. The balloon 12 has a head 18 and an elongated neck 20 extending between the body 14 and the head 18. Thus, the balloon 12 has the ornamental appearance of a water fowl in flight thereby facilitating the balloon 12 to attract water fowl.

A valve 22 is provided and the valve 22 is coupled to the balloon 12. Moreover, the valve 22 is in fluid communication with an interior of the balloon 12. The valve 22 facilitates the balloon 12 to be selectively inflated and deflated. The valve 22 may be a two way fluid valve 22 or the like.

The body 14 has a bottom surface 24. A dot 26 is printed on the bottom surface 24. The dot 26 has a color that contrasts with a color of the balloon 12. Thus, the dot 26 is visible from the ground. The color of the dot 26 may be hunter orange.

A restraint 28 is provided. The restraint 28 is positioned on the ground such and restraint 28 is positioned in a selected area. The selected area may be a water fowl hunting area or the like. The balloon 12 is coupled to the restraint 28. Thus, the restraint 28 retains the balloon 12 near the selected area.

The restraint 28 comprises a catch 30 that is coupled to the bottom surface 24 of the body 14. A tether 32 is provided and the tether 32 is selectively attached to the balloon 12. Thus, the tether 32 retains the balloon 12 near a selected area. The tether 32 is tied to the catch 30 and the tether 32 has a distal end 34 with respect to the catch 30. The tether 32 may have a length ranging between approximately six meters and twelve meters.

An anchor 36 is provided. The anchor 36 is selectively positioned on the ground. The tether 32 is tied to the anchor 36. Thus, the anchor 36 retains the balloon 12 in the selected area. The anchor 36 may be a weighted bag, a block or other weighted object.

In use, the balloon 12 is inflated with helium. The anchor 36 is positioned on the ground in the selected area. The tether 32 is attached to the anchor 36 and the balloon 12 is released. Thus, the balloon 12 floats in the air above the anchor 36. The balloon 12 simulates a flying water fowl when the balloon 12 floats in the air. Thus, the balloon 12 attracts water fowl for hunting purposes. A plurality of the balloon 12s and anchor 36s may be deployed in the selected area.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A flying decoy assembly being configured to simulate water fowl in flight, said assembly comprising:
a balloon being configured to be filled with helium thereby facilitating said balloon to float in the air, said balloon having a body, a pair of wings extending away from said body, a head and an elongated neck extending between said body and said head wherein said balloon is configured to have the ornamental appearance of a water fowl in flight thereby facilitating said balloon to attract water fowl; and
a restraint being configured to be positioned on the ground such that said restraint is positioned in a selected area, said balloon being coupled to said restraint wherein said restraint is configured to retain said balloon near the selected area.

2. The assembly according to claim 1, further comprising said body having a bottom surface, said bottom surface having a dot being printed thereon, said dot having a color being contrasting with a color of said balloon wherein said dot is configured to be visible from the ground.

3. The assembly according to claim 2, wherein said restraint comprises a catch being coupled to said bottom surface of said body.

4. The assembly according to claim 2, wherein said restraint comprises:
a catch being coupled to said bottom surface of said body; and
a tether being selectively attached to said balloon wherein said tether is configured to retain said balloon in a selected area, said tether being tied to said catch, said tether having a distal end with respect to said catch.

5. The assembly according to claim 4, further comprising an anchor being configured to be positioned on the ground, said tether being tied to said anchor wherein said anchor is configured to retain said balloon in the selected area.

6. A flying decoy assembly being configured to simulate water fowl in flight, said assembly comprising:
a balloon being configured to be filled with helium thereby facilitating said balloon to float in the air, said balloon having a body, a pair of wings extending away from said body, a head and an elongated neck extending between said body and said head wherein said balloon is configured to have the ornamental appearance of a water fowl in flight thereby facilitating said balloon to attract water fowl, said body having a bottom surface, said bottom surface having a dot being printed thereon, said dot having a color being contrasting with a color of said balloon wherein said dot is configured to be visible from the ground; and
a restraint being configured to be positioned on the ground such that said restraint is positioned in a selected area, said balloon being coupled to said restraint wherein said restraint is configured to retain said balloon near the selected area, said restraint comprising:
a catch being coupled to said bottom surface of said body;
a tether being selectively attached to said balloon wherein said tether is configured to retain said balloon in a selected area, said tether being tied to said catch, said tether having a distal end with respect to said catch; and
an anchor being configured to be positioned on the ground, said tether being tied to said anchor wherein said anchor is configured to retain said balloon in the selected area.
